(19) United States
(12) Patent Application Publication
(10) Pub. No.: US 2025/0277912 A1
(43) Pub. Date: Sep. 4, 2025

(54) Algorithm and Method to Calculate Trajectory Lengths of Buried Cables

(71) Applicant: Metrotech Corporation, Santa Clara, CA (US)

(72) Inventors: William Moore, Devon (GB); Stephen John Petherick, Devon (GB)

(21) Appl. No.: 19/062,716

(22) Filed: Feb. 25, 2025

Related U.S. Application Data
(60) Provisional application No. 63/559,768, filed on Feb. 29, 2024.

(51) Int. Cl. G01S 19/39; G01S 19/51

(52) U.S. Cl. CPC G01S 19/393; G01S 19/51

(57) ABSTRACT

A method of determining the real length of underground cables in a line location receiver having a spatial array of 6 antennas, wherein the antennas can receive and measure a phase coherent low frequency alternating magnetic field emanating from a buried conductor that is energized by a signal generator, wherein the antennas are arranged in 2 sets each comprising sensors on 3 orthogonal axes, includes computing a relative position of a buried conductor that includes both the cable depth and the transverse offset relative to a magnetic axis of the line location receiver, the transverse offset being vector at 90° to the buried conductor trajectory; and determining the real trajectory length of a buried cable from defined start and end positions from the relative positions.

### RELATED APPLICATIONS

This application claims priority to U.S. Provisional Patent Application No. 63/559,768 filed Feb. 29, 2024, which is incorporated by reference herein in its entirety.

### BACKGROUND

### Technical Field

The current application is related to location of an underground cable.

### Discussion of Related Art

Underground utility location and utility installation are common problems for utility companies and local municipalities. Several solutions have been developed to address these problems. In one case, where location of an underground cable or conducting pipeline is needed, an underground pipe and cable location system (often termed a line locator system) can be used. In that system, an above ground receiver detects magnetic signals transmitted by the underground pipe or cable in order to locate the pipe or cable. In another system, a sonde placed within a pipe or as part of a drilling rig can emit electromagnetic radiation that is detected by the above ground receiver to locate the position of the sonde. In some cases, markers can be located proximate the utility and are then used to locate the utility. The current disclosure is directed towards operations that involve locating an underground cable or line.

Underground line locators typically include a transmitter coupled to the underground line to be locating and a remote receiver. Such systems are well known and used within industry sectors who manage buried assets. The principle of emitting an electromagnetic field from an underground line and then locating the line with an above-ground receiver is well used. In the simplest applications the underground line is driven by a coupled transmitter to emit electromagnetic signals that allow phase sensitive measurement of the resulting magnetic fields with the receiver. Receivers engaged in underground line location often include an array of spaced apart antennas (typically between 2 and 6 antennas) and can use the principles of phase coherence to derive directional and distance information to the underground by correlating the measured signals and their relative phases.

However, precise location of the underground cable is depending on the length of the cable being located. Determination of this length is often very imprecise.

Consequently, there is a need for better determination of cable length in order to provide more precise location of underground lines.

### SUMMARY

A method of determining the real length of underground cables in a line location receiver having a spatial array of 6 antennas, wherein the antennas can receive and measure a phase coherent low frequency alternating magnetic field emanating from a buried conductor that is energized by a signal generator, wherein the antennas are arranged in 2 sets each comprising sensors on 3 orthogonal axes, includes computing a relative position of a buried conductor that includes both the cable depth and the transverse offset relative to a magnetic axis of the line location receiver, the transverse offset being vector at 90° to the buried conductor trajectory; and determining the real trajectory length of a buried cable from defined start and end positions from the relative positions.

In some embodiments, the line locating receiver is equipped with a GNSS device, where the GNSS device can be anything in a range of GNSS solutions starting from a standard precision receiver to a Real Time Kinetic system with ground-based corrections applied in real-time. In some embodiments, the line location receiver samples GNSS data at a fixed rate, or at a defined threshold distance from a previous position or at instances initiated by the user.

In some embodiments, the line location receiver measures the real trajectory length of a buried cable from defined start and end positions. In some embodiments, the transverse offset vector is used with the locators real GNSS heading vector to compute a projection of the cable trajectory and where said cable trajectory is mapped to a real GNSS grid. In some embodiments, the total cable length from the start to end positions is the vector sum of all the finite elements.

In some embodiments, the line locating receiver has real-time connectivity to a Cloud Webserver and all measurement data is automatically synchronized with the Cloud Data. In some embodiments, calculations of cable trajectory and cable length can be performed within the Cloud Webserver

These and other embodiments will be described in further detail below with respect to the following figures.

### BRIEF DESCRIPTION OF THE DRAWINGS

FIG. 1 illustrates a line locating system according to some embodiments of the present disclosure.

FIGS. 2 illustrates the geometry of a line location receiver according to some embodiments of the present disclosure.

FIGS. 3A and 3B illustrate the magnetic field generated around an underground cable and placement of the line location receiver on the surface relative to that underground cable.

FIGS. 4A and 4B illustrate locating the underground cable with a line locator system.

FIGS. 5A, 5B, and 5C illustrates the fields and location of an underground utility when there are multiple cables.

FIGS. 6A and 6B illustrate displays indicating location of an underground cable.

FIG. 7 illustrates two versions of line location receiver according to some embodiments.

FIG. 8 illustrates location of an underground cable at a location.

FIG. 9 illustrates receiver position versus cable position for several locations of a line location receiver according to some embodiments.

FIG. 10 illustrates communication of a line locator receiver according to some embodiments with a cloud-based server.

FIG. 11 illustrates test results using embodiments according to the present disclosure.

The drawings may be better understood by reading the following detailed description.

### DETAILED DESCRIPTION

In the following description, specific details are set forth describing some aspects of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. Such modifications may include substitution of known equivalents for any aspect of the disclosure in order to achieve the same result in substantially the same way.

Consequently, this description illustrates inventive aspects and embodiments that should not be taken as limiting—the claims define the protected invention. Various changes may be made without departing from scope of this description and the claims. In some instances, well-known structures and techniques have not been shown or described in detail in order not to obscure the invention.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Further, individual values provided for particular components are for example only and are not considered to be limiting. Specific dimensional values for various components are there to provide a specific example only and one skilled in the art will recognize that the aspects of this disclosure can be provided with any dimensions. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Embodiments of this disclosure improve the quality of services provided by an electro-magnetic cable locating system. An adaptive triangulating system is used in conjunction with an electro-magnetic line locating receiver to estimate the real length of a buried utility between defined start and end positions.

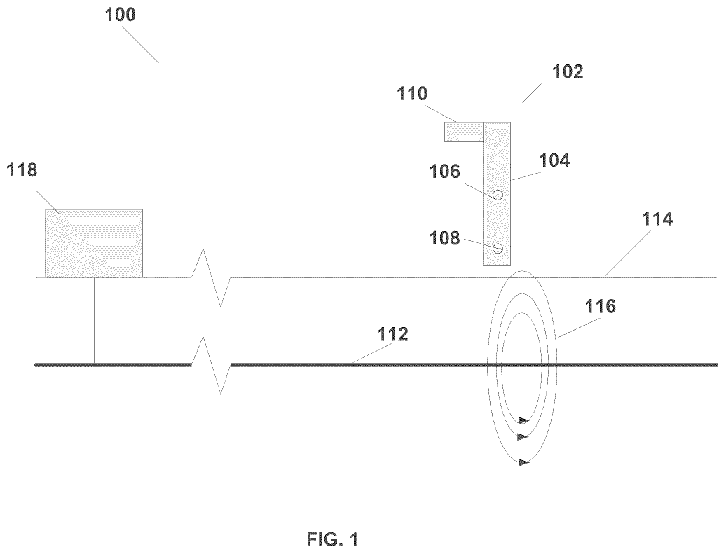

FIG. 1 illustrates a line locating system 100 locating an underground line (or cable) 112. As indicated in FIG. 1, a transmitter 118 is coupled to line 112. Transmitter 118 may be directly coupled to line 112 or may be inductively coupled to line 112. In either case, transmitter 118 drives a current onto line 112, which generates an electromagnetic field 116. The electromagnetic field can be considered a low-frequency electromagnetic field.

Receiver 102 is locating above surface 114 and usually can be handheld by an operator. Typically, receiver 102 includes a wand 104 where one or more antennas are positioned. Antennas in this antenna array can be spaced apart in both horizontal and vertical configurations in order to map magnetic field 116 and each antenna in the array can be 1D, 2D, or 3D antenna configurations. In the example of FIG. 1, antennas 106 and 108 are illustrated and positioned within wand 104. Antennas 106 and 108 can each be 3-D antennas (also referred to as triaxial antennas), 2-D antennas, or 1-D antennas. Further, there can be other antennas in wand 104 that provide signals that can be used to calculate various characteristics of magnetic field 116. A 3-D, or triaxial, antenna can include three individual coils that are positioned relative to one another to measure magnetic fields in three orthogonal directions at a point at the center of the antenna. Signals from antennas 106 and 108 can be processed within receiver 102 and the results displayed on a user interface 110. In some examples, the results can include the determination of the position and depth of line 112 relative to receiver 102.

Utility Locators as illustrated in FIG. 1, comprising a Signal Source (Transmitter) and a Cable Locator (Receiver), are well known and used within industry sectors who own and manage buried assets. The principle of inducing an alternating current directly on to a utility allows both pinpoint locating and depth measurements to be made. In the simplest applications sinewave signals are used to allow phase sensitive measurements of the resulting magnetic field. Modern Cable locators have an array of spaced apart antennas (typically between 2 and 6) and can use the principles of phase coherence to derive directional information from the correlation of the measured signals to the known geometrical shape of a magnetic field.

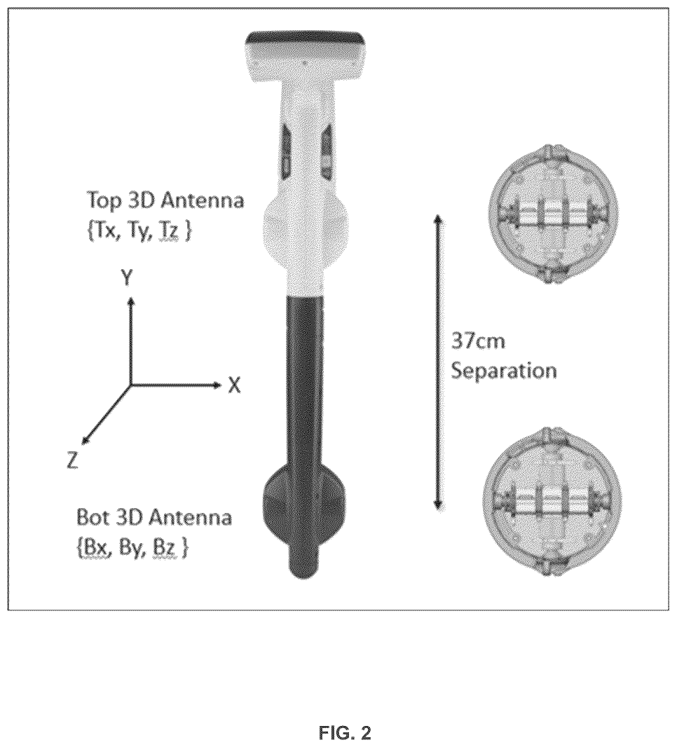

The vLoc3-Pro series locators produced by Vivax-Metrotech, which is illustrated in FIG. 2, have 6 antennas which are grouped in 2 sets of mutually orthogonal devices and spaced apart by ˜37 cm. This 6-channel arrangement yields a capable platform for performing vector geometry on a real 3D magnetic field.

In the system illustrated in FIG. 2, the magnetic field measurements {Bx, Tx, By, Ty} use sensor coils wound on a ferrite core with high magnetic permeability. The orthogonal measurements {Bz, Tz} use an air cored sensor which encapsulates the overall enclosure. The combined measurements result in a true description of the magnetic vector:

$$\begin{matrix}\vec{B} = \sqrt{{Bx}^{2} + {By}^{2} + {Bz}^{2}} \\ \vec{T} = \sqrt{{Tx}^{2} + {Ty}^{2} + {Tz}^{2}}\end{matrix}$$

The vector directions come from the phase sensitive measurements of the component measurements:

$$\vec{Bx} = [ \frac{Bx}{\sqrt{{Bx}^{2} + {By}^{2} + {Bz}^{2}}} ] \cdot \vec{x} \qquad \vec{By} = [ \frac{By}{\sqrt{{Bx}^{2} + {By}^{2} + {Bz}^{2}}} ] \cdot \vec{y} \qquad \vec{Bz} = [ \frac{Bz}{\sqrt{{Bx}^{2} + {By}^{2} + {Bz}^{2}}} ] \cdot \vec{z}$$

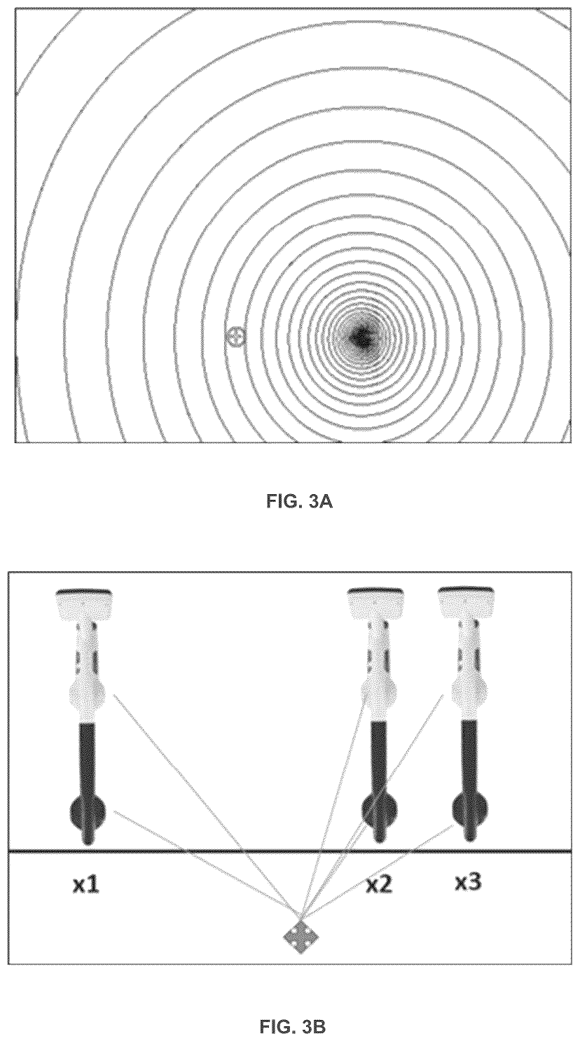

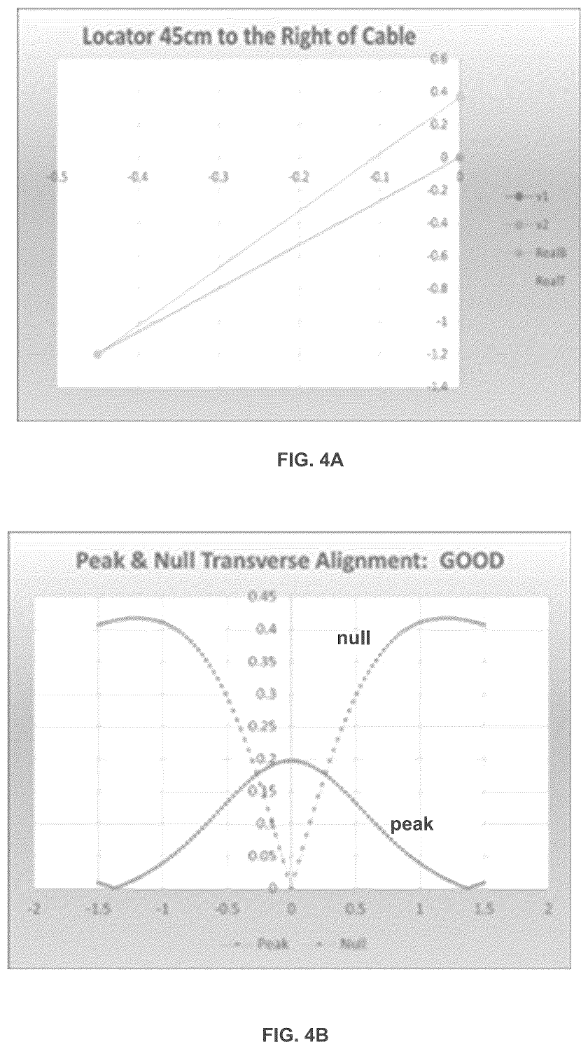

FIGS. 3A and 3B illustrate a process that allow consideration of a set of orthonormal vectors which emanate from the current element (the underground cable) flowing in the buried conductor (utility). In the instance of a current flowing in one buried conductor the magnetic field the shape is a pure radial field with an inverse 1/r dependency, as illustrated in FIG. 3A. In these circumstances the orthonormal vectors from the Top and Bottom antenna sets intersect at an exact point, as is illustrated in FIG. 4A. As illustrated in FIG. 4A, the real T and real B are calculate and used to determine the location of the field. In FIG. 4A, the horizontal position and vertical position (depth) are shown along with measurements from two antennas positioned vertically. The traditional peak and null locate responses, therefore, coincide at the same position above the cable. The peak and null locate responses are illustrated in FIG. 4B. Consequently, using multiple locations as illustrated in FIG. 3B allows for accurate measurements of the location of the underground cable.

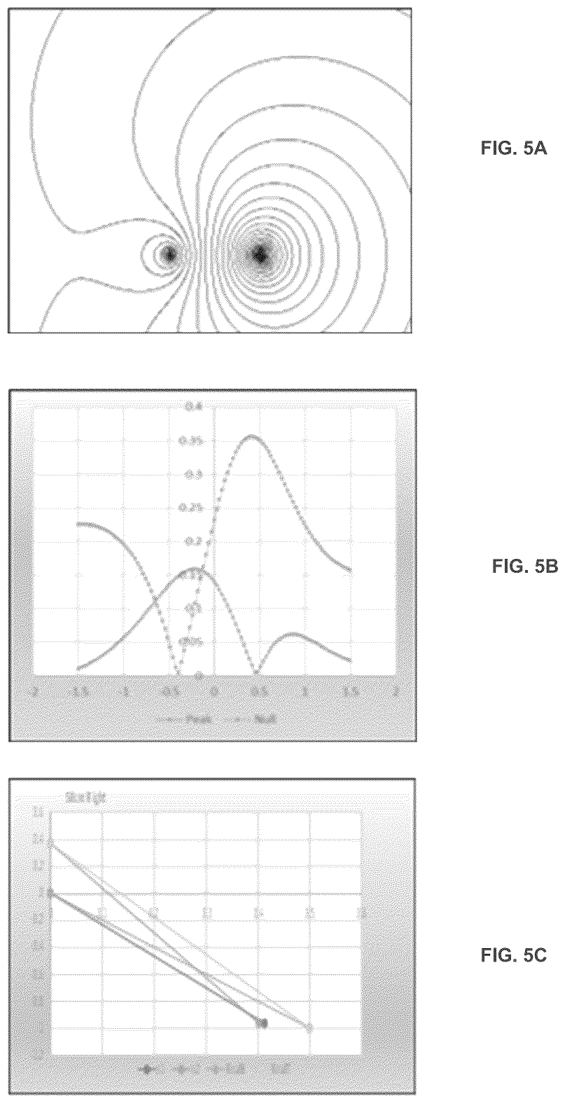

In circumstances when the tracing current is split between more than one buried conductor, as is illustrated in FIGS. 5A, 5B, and 5C, the magnetic field shape departs from radial geometry and tends towards a dipole field shape. In these circumstances the Top and Bottom orthonormal vectors do not intersect at a point (or at any point) and the Peak and Null manual responses do not align. As illustrated in FIG. 5C, the of data intersect in two positions (corresponding to the two lines illustrated in FIG. 5A).

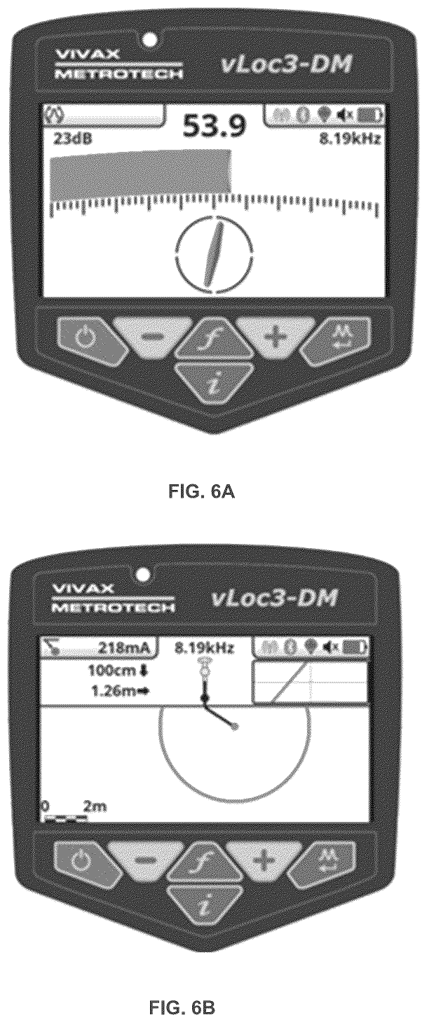

Vivax-Metrotech has a proprietary algorithm which computes the best intersection of the distorted orthonormal vectors and still allows a computation of the real position of the cable—both the depth and the transverse offset, which is illustrated in the displays shown in FIGS. 6A and 6B. Accuracy is compromised when the field distortion is high, but this is still a significant improvement over the alternative with no computation, which is inherent to locators with less than six (6) antenna channels.

Companies involved in contract locating typically deploy ticket management systems to administrate the process of locating one or more buried utilities at a defined address. Each buried utility may have one or more sections of buried utility to locate. Each section of buried utility will have a defined start and end position that can be determined by a GNSS device. An improvement to existing practices would be to estimate the true length of the buried utility between the start and end points—such a calculation needs to factor in the true path a utility takes (the trajectory) and would be invariably bigger than simply calculating the direct line between the start and end positions.

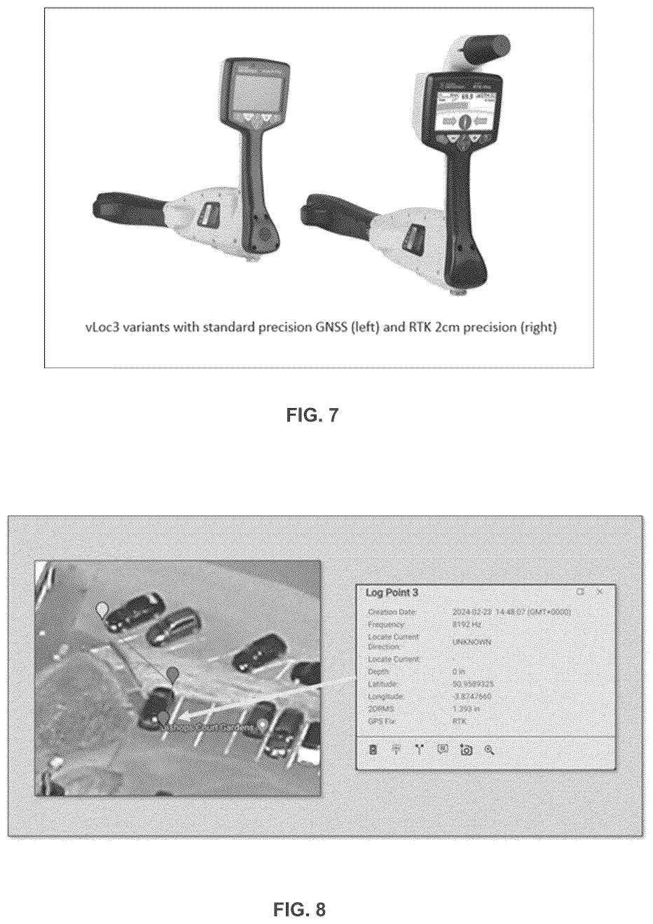

All location surveying requires a reference to a true geographical grid (latitude and longitude) and this invariably requires an integrated GNSS device. Such devices are available with a range of accuracies. Standard precision GNSS devices yield a horizontal positional accuracy of 1.5 m Circular Error Probable (CEP) while high precision Real Time Kinetic (RTK) GNSS systems, using ground-based corrections, can give horizontal positional accuracies of 0.01 m CEP. The vLoc3-Pro series of locators offer all such positional accuracies, and it is worth noting that survey quality and all estimates of utility location will be inextricably linked to the GNSS accuracy. Two versions of the Vivax-Metrotech line location receivers, one with standard precession and one with precise positioning, are illustrated in FIG. 7.

Existing systems and methods facilitate crude estimates of the length of a buried utility. Typically, a set of place markers are generated at positions where the user arbitrates the locator to be directly overhead the utility, as is illustrated in FIG. 8. The length of the utility is then calculated using the standard haversine equation which determines the great circle distance between two (2) defined points on the earth's surface. The computed utility length is then the piecewise summation of the distance between all the logged place-markers.

L_{U}=Σ|Hₙ|

There are multiple problems which render the existing methods inaccurate. First, Locators with less than 6 spaced antennas cannot determine a utility position in either relative or absolute terms. Such locators require human interpretation to arbitrate a point where it is believed they are directly above the utility. Such human interpretation is subject to any amount of error, and it is not even possible to estimate how inaccurate this procedure may be.

Further, the above equation for the peakwise summation of the distance assumes that the distance-event sampling between successive points is sufficient to capture the true trajectory of the cable. In real circumstances the utility may well change direction several times between the logged sampling positions, resulting in an inaccurate summation.

Additionally, in circumstances where a cable position is inaccessible there is no possibility of making a position estimate as this requires the transverse offset measurement. The transverse offset measurement is intrinsic to the 6-antenna locator and not to other locators.

In addition, existing work practices are slow because they are reliant on defined measurement points that require the operator to stop and assess whether the locator is directly above the cable at each point.

Embodiments of the present disclosure calculate the true length of a buried utility between defined start and end positions. Such information is valuable to organizations who may use it to set the cost of a service rendered-for example the One-Call Locate as practiced in the USA. Some embodiments of the present disclosure can be operated on a locator having 6 antennas comprising 2 sets of {x,y,z} mutually orthogonal antennas. In some embodiments, the locator includes an algorithm for calculating the transverse offset of the locator with respect to the buried cable. The transverse offset algorithm employes a signing convention, for example left is negative and right is positive.

Further, in some embodiments the locator includes an integrated GNSS device. The overall accuracy of the utility distance calculation can be directly related to the accuracy of the GNSS receiver so an RTK system with base station correction is preferable for most cases. However, any accuracy GNSS receiver can be used.

In some embodiments, there is a defined start and end point as identified to the locate technician. This information helps with the calculation of the trajectory of the utility according to embodiments of the present disclosure.

In accordance with embodiments of the present disclosure, the locator can also take locate data and, based on that data, determine the trajectory of the underground utility. In some embodiments, the locate data and the trajectory can be determined remotely, as discussed below. Acquisition of the locate data may be achieved by a variety of mechanisms, some of which are discussed below. It should be noted that other data acquisition schemes can be used to provide data for embodiments of the present disclosure.

In some embodiments, In-Time sampling is employed. In-Time sampling refers to on-the-fly measurements of all relevant data at a fixed sampling period. Typical sampling frequencies would be anything from 0.1 Hz to 10 Hz. The faster the sampling rate the more accurate the end calculation would be. A disadvantage of such a fixed rate sampling system is it generates somewhat verbose data relative to the real information content, all of which would be analyzed to determine the trajectory of the underground utility.

In some embodiments, positional change sensitive sampling can be used. Positional change sensitive sampling is a more data efficient mechanism and only samples if the GNSS positional fix has moved by more than a defined amount-typically 0.5 m for high resolution and 2 m if less accuracy is required. This sampling method results in much more efficient data acquisition.

In some embodiments, manual sampling can be used. In manual sampling, the operator determines when the locate data is taken. This method is dependent on the operator taking the appropriate amount of data to determine a trajectory of the underground utility.

The method of calculating the true utility length uses a series of finite element triangulation calculations based on the locate data that has been acquired. The true grid reference is derived from the GNSS fixes for latitude and longitude. For the purposes of this disclosure, X denotes longitude and Y denotes latitude. The displacement in X and Y from successive sample positions are calculated as follows:

$$Δ {x}_{n} = ( {x}_{n} - {x}_{n - 1} ) . cos ( {y}_{n} ) . R and Δ {y}_{n} = ( {y}_{n} - {y}_{n - 1} ) . R$$

where:
Xₙ and Yₙ are the latitude and longitude of the sampled position ‘n’ measured in radians; and
R is the radius of the earth at the locate position.

There are multiple ways this can be managed depending on the accuracy required. Known polynomials that provide effective lengths on the Earth's surface give the effective lengths on the Earth's surface for one (1) degree of latitude and longitude. Such corrections do have a bearing on the overall calculation of the utility length, but using an average value for the Radius is sufficient in most applications.

FIG. 9 illustrates the positions of the locator at successive samples shown in green and the estimated cable utility positions, sampled at the same instances are shown in yellow. The vector Hn is calculated from the measured latitude and longitude relative to the previous positional fix. The vector Un is the projection of the transverse measurement in the direction of the orthogonal vector to Hn. The yellow markers are therefore projections of the estimated cable position using the magnitude of the transverse offset Tn at 90° to the direction of vector Hn:

$$\vec{{H}_{n}} = ( \begin{matrix}Δ {x}_{n} \\ Δ {y}_{n}\end{matrix} )$$

Given a signed transverse offset Tn at each point, a vector offset can then be approximated as an orthogonal projection:

$$\vec{{V}_{n}} = \frac{{T}_{n}}{\sqrt{Δ {{x}_{n}}^{2} + Δ {{y}_{n}}^{2}}} ( \begin{matrix}Δ {y}_{n} \\ - Δ {x}_{n}\end{matrix} )$$

During a typical site survey, the locator will traverse the cable multiple times. Accordingly, the Haversine summation described previously will overestimate the true cable trajectory. The invention overcomes this weakness by factoring in the true projection of the cable using a series of finite element projections. The total estimated utility length is then the summation of all the finite element projections:

$$UT = {\sum }_{n = 0}^{N} {U}_{n}$$

The initial conditions of this process assume the start position is directly above the buried utility. Similarly, the end survey point is assumed to also coincide. All stated equations obey the rules of vector geometry. There are many ways by which the cable trajectory distance can be calculated. Embodiments of the present disclosure should not be confined within the details of any one vector-geometry, but it is the use of the transverse offset vector to provide for calculation of the projected trajectory of the cable position.

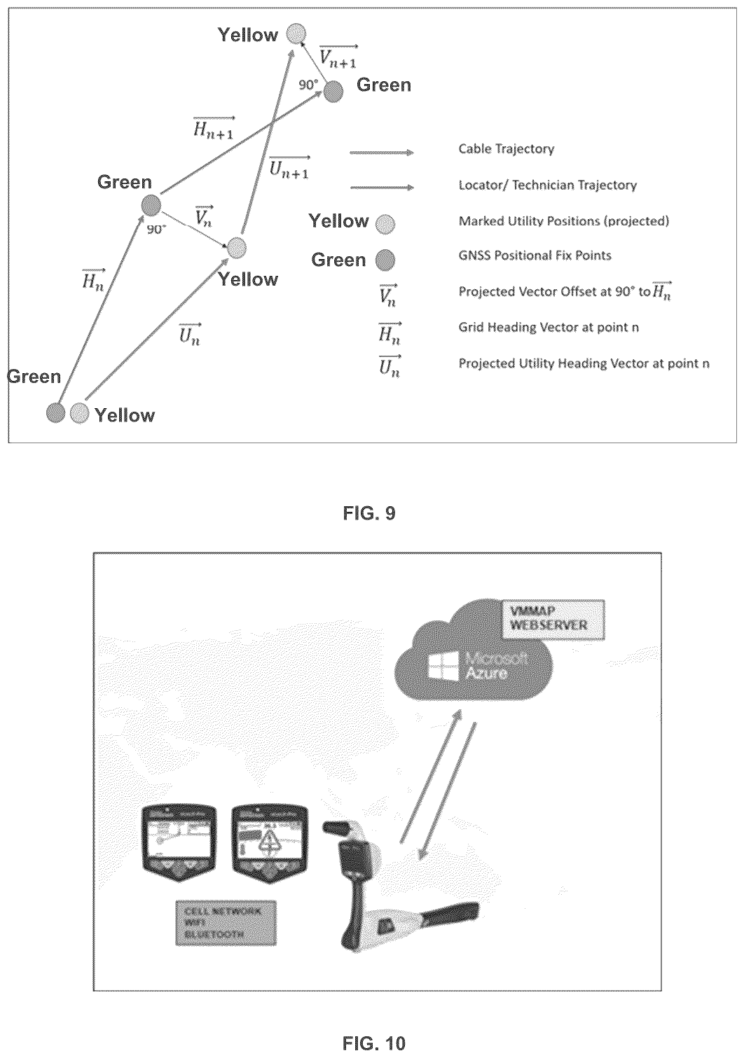

Modern cable locating instruments have a live data link to a Cloud Webserver as is shown in FIG. 10. This link includes an auto-synchronization mechanism to cover off-line outages, with no loss of data. All measurement data from the locator, magnetic vectors and GNSS information, can be stored and managed within a Cloud Data Base. Accordingly, the vector-geometry calculations described can be hosted both on the locator or by the Cloud Webserver. The more cost-effective option is to perform the calculations on the locator as typically Cloud Webservers charge for computational mathematics.

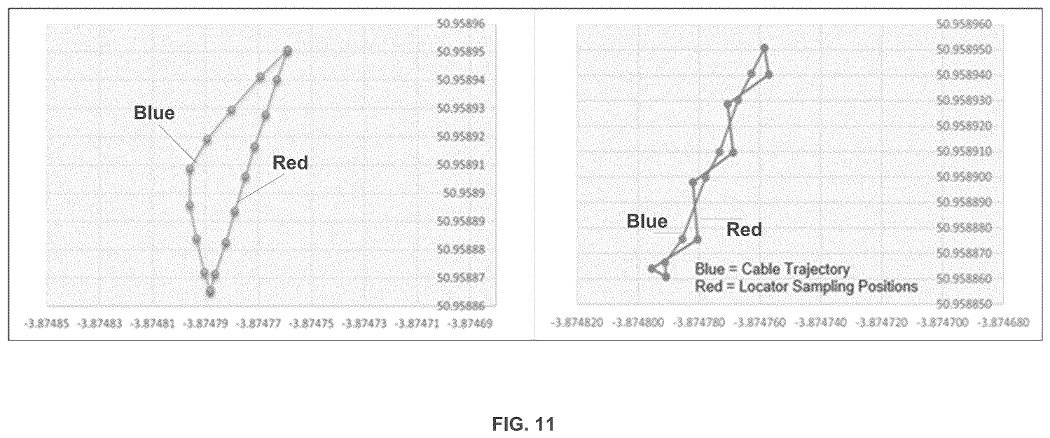

Embodiments of the present disclosure improve the accuracy of the trajectory length calculation over and above the existing state of the art. This is accomplished through integration of the Transverse Offset Vector. The test results, illustrated in FIG. 11, have revealed significant improvements in accuracy and that embodiments of the present disclosure overcome the stated problems. Achieving an overall cable trajectory length within three percent (3%) would seem to be a reasonable estimate and significantly improved on existing methods, which have undefined and inherent errors.

Embodiments of the present disclosure are implemented on a line location receiver having a spatial array of six (6) antennas, wherein the antennas can receive and measure a phase coherent low frequency alternating magnetic field emanating from a buried conductor that is energized by a signal generator. In some embodiments, the antennas are arranged in two (2) sets each comprising sensors on three (3) orthogonal axes.

The line location receiver is capable of computing a relative position of a buried conductor that includes both the cable depth and the transverse offset relative to a magnetic axis of the line location receiver, the transverse offset being vector at 90° to the buried conductor trajectory.

In some embodiments, the line locating receiver is equipped with a GNSS device, where the GNSS device can be anything in a range of GNSS solutions starting from a standard precision receiver to a Real Time Kinetic system with ground-based corrections applied in real-time. In some embodiments, the line location receiver samples GNSS data at a fixed rate, or at a defined threshold distance from a previous position or at instances initiated by the user.

In accordance with some embodiments, the line location receiver measures the real trajectory length of a buried cable from defined start and end positions. In some embodiments, the transverse offset vector is used with the locators real GNSS heading vector to compute a projection of the cable trajectory and where said cable trajectory is mapped to a real GNSS grid. In some embodiments, the total cable length from the start to end positions is the vector sum of all the finite elements.

In some embodiments, the line locating receiver has real-time connectivity to a Cloud Webserver and all measurement data is automatically synchronized with the Cloud Data. In some embodiments, calculations of cable trajectory and cable length can be performed within the Cloud Webserver

In the preceding specification, various embodiments have been described with reference to the accompanying drawings. It will, however, be evident that various modifications and changes may be made thereto, and additional embodiments may be implemented, without departing from the broader scope of the invention as set for in the claims that follow. The specification and drawings are accordingly to be regarded in an illustrative rather than restrictive sense.

What is claimed is:

1. A method of determining the real length of underground cables in a line location receiver having a spatial array of 6 antennas, wherein the antennas can receive and measure a phase coherent low frequency alternating magnetic field emanating from a buried conductor that is energized by a signal generator, wherein the antennas are arranged in 2 sets each comprising sensors on 3 orthogonal axes, comprising:
computing a relative position of a buried conductor that includes both the cable depth and the transverse offset relative to a magnetic axis of the line location receiver, the transverse offset being vector at 90° to the buried conductor trajectory;
determining the real trajectory length of a buried cable from defined start and end positions from the relative positions.

2. The method of claim 1, wherein the line locating receiver is equipped with a GNSS device, where the GNSS device can be anything in a range of GNSS solutions starting from a standard precision receiver to a Real Time Kinetic system with ground-based corrections applied in real-time.

3. The method of claim 2, wherein the line location receiver samples GNSS data at a fixed rate, or at a defined threshold distance from a previous position or at instances initiated by the user.

4. The method of claim 2, wherein the line location receiver measures the real trajectory length of a buried cable from defined start and end positions.

5. The method of claim 4, wherein the transverse offset vector is used with the locators real GNSS heading vector to compute a projection of the cable trajectory and where said cable trajectory is mapped to a real GNSS grid.

6. The method of claim 5, wherein the total cable length from the start to end positions is the vector sum of all the finite elements.

7. The method of claim 6, wherein the line locating receiver has real-time connectivity to a Cloud Webserver and all measurement data is automatically synchronized with the Cloud Data.

8. The method of claim 7, wherein calculations of cable trajectory and cable length can be performed within the Cloud Webserver.
